(19) United States
(12) Patent Application Publication
(10) Pub. No.: US 2008/0253254 A1
(43) Pub. Date: Oct. 16, 2008

(54) Optical disc player

(75) Inventor: Yoshikazu Onishi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/078,843

(22) Filed: Apr. 7, 2008

(30) Foreign Application Priority Data
Apr. 10, 2007 (JP) 2007-102377

(51) Int. Cl. G11B 7/28

(52) U.S. Cl. 369/84

(57) ABSTRACT

An optical disk player includes: an installation judgment part judging whether or not a USB memory has been installed; a stored information judgment part, when the installation judgment part judges that the USB memory has been installed, judging whether or not the USB memory stores reproducible information; and a reproduction execution part, when the stored information judgment part judges that the USB memory stores the reproducible information, reading the reproducible information stored in the USB memory to achieve reproduction.

This application is based on Japanese Patent Application No. 2007-102377 filed on Apr. 10, 2007, the contents of which are hereby incorporated by reference.

### BACKGROUND OF THE INVENTION

1. Field of the Invention

The present invention relates to an optical disc player that reads reproducible information from a removable recording medium to achieve reproduction, and more specifically to an optical disc player that reads at least either of audio information and image information from a removable USB memory to achieve reproduction.

2. Description of Related Art

In recent years, following wide spread use of a portable memory, such as a USB (Universal Serial Bus), it has become possible to store into the USB memory or the like audio information, image information, etc. downloaded via the Internet.

For improved user friendliness, various devices and methods have been suggested which achieve reproduction (hereinafter reproduction denotes reproducing an image sound, or the like, from information or data recorded on a medium) on an optical player or the like, from audio data stored in a USB memory or the like. For example, a data reproduction device has been disclosed which can achieve reproduction from audio information stored in a USB memory or the like (JP-A-2005-56479).

However, achieving the reproduction from the audio information or the like stored in the USB memory or the like has required selecting one from among pieces of reproducible information stored in the USB memory and then performing operation input for executing the reproduction, which may not be sufficiently convenient in some cases.

### SUMMARY OF THE INVENTION

In view of the problem described above, it is an object of the present invention to provide an optical disc player capable of achieving with high convenience reproduction from reproducible information stored in a removable recording medium.

To achieve the object described above, an optical disk player according to one aspect of the invention includes: an installation judgment part judging whether or not a removable recording medium has been installed; a stored information judgment part, when the installation judgment part judges that the recording medium has been installed, judging whether or not the recording medium stores reproducible information; and a reproduction execution part, when the stored information judgment part judges that the recording medium stores the reproducible information, reading the reproducible information stored in the recording medium to achieve reproduction.

With this configuration, when it is judged that the recording medium has been installed and that the recording medium stores the reproducible information, the reproducible information stored in the recording medium is read to achieve reproduction. Therefore, the reproduction from the reproducible information stored in the recording medium can be started without operation input by the user, so that the reproduction from the reproducible information stored in the removable recording medium can be achieved with high convenience.

Preferably, the optical disk player described above further includes: a power judgment part, when the installation judgment part judges that the recording medium has been installed, judging whether a power of the optical disk player is ON or OFF; and a power-on part, when the power judgment part judges that the power is OFF, turning the power on.

With this configuration, when the power judgment part judges that the power is OFF, the power is turned ON; thus, even when the power is OFF, the reproduction from the reproducible information stored in the recording medium can be started without operation input by the user for turning the power ON, so that the reproduction from the reproducible information stored in the removable recording medium can be achieved with high convenience.

Preferably, in the optical disk player described above, the stored information judgment part judges whether or not the recording medium stores a plurality of pieces of the reproducible information; when the stored information judgment part judges that the recording medium stores the plurality of pieces of the reproducible information, the reproduction execution part selects, from among the plurality of pieces of the reproducible information, one piece of the reproducible information in accordance with a preset rule; and the selected one piece of the reproducible information is read to achieve the reproduction.

With this configuration, when it is judged that the recording medium stores the plurality of the reproducible information, the reproduction execution part selects, from among the plurality of pieces of the reproducible information, one piece of the reproducible information in accordance with the preset rule, and the selected one piece of the reproducible information is read to achieve the reproduction. Therefore, even when the recording medium stores the plurality of pieces of the reproducible information, the reproduction from the reproducible information stored in the recording medium can be started without operation input by the user for selecting reproduction target information. Thus, the reproduction from the reproducible information stored in the removable recording medium can be achieved with even higher convenience.

Preferably, in the optical disk player described above, when the stored information judgment part judges that the recording medium stores the plurality of the reproducible information, the reproduction execution part selects, from among the plurality of pieces of the reproducible information, one piece of the reproducible information located at a foremost side in File Allocation Tables stored in the recording medium, and the selected one piece of the reproducible information is read to achieve the reproduction.

With this configuration, when it is judged that the recording medium stores the plurality of pieces of the reproducible information, from among the plurality of pieces of the reproducible information, one piece of the reproducible information located at the foremost side in the File Allocation Tables stored in the recording medium is selected, and the selected one piece of the reproducible information is read to achieve the reproduction. Thus, even when the recording medium stores the plurality of the reproducible information, reproduction target information can be selected with simple configuration, so that the reproduction from the reproducible information stored in the removable recording medium can be achieved with even higher convenience.

Preferably, the optical disk player described above further includes a reproduction setting part receiving operation input from outside, and based on the received operation input, setting whether or not the reproduction execution part performs the reproduction from the information stored in the recording medium; and a prohibition part, when the reproduction setting part has set “reproduction is not to be achieved”, prohibiting operation of the reproduction execution part.

With this configuration, when the reproduction setting part has set “reproduction is not to be achieved” from the information stored in the recording medium, the reproduction operation is prohibited; thus, when the user does not desire reproduction, the reproduction operation can be prohibited by setting “reproduction is not to be achieved”. Thus, the reproduction from the reproducible information stored in the removable recording medium can be achieved with even higher convenience.

Preferably, in the optical disk player described above, the reproducible information includes at least either of audio information and image information. Thus, the reproduction from either of the audio information and the image information stored in the removable recording medium can be achieved with even higher convenience.

Preferably, in the optical disk player described above, the recording medium is a USB memory. Thus, the reproduction from the reproducible information stored in the removable USB memory can be achieved with even higher convenience.

### BRIEF DESCRIPTION OF THE DRAWINGS

FIG. 1 is a block diagram showing one example of configuration of a DVD player according to the present invention;

FIG. 2 is a functional configuration diagram showing one example of configuration of main parts in the DVD player according to the invention; and

FIG. 3 is a flowchart showing one example of operation performed by the DVD player (mainly microprocessor).

### DETAILED DESCRIPTION OF PREFERRED EMBODIMENTS

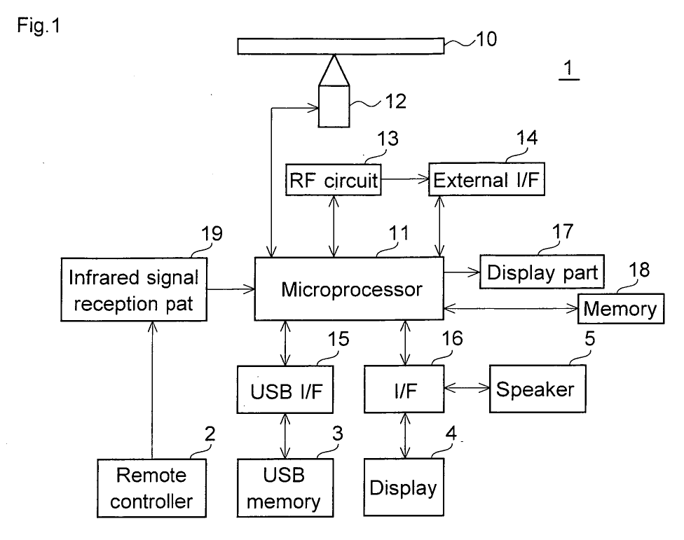

An embodiment of the present invention will be described with reference to the accompanying drawings. FIG. 1 is a block diagram showing one example of configuration of a DVD player 1 according to the invention.

The DVD player 1 (corresponding to an optical disc player) achieves reproduction from audio information, image information, etc. stored in a DVD (Digital Versatile Disc) (or a CD (Compact Disk)) or a USB memory 3. The DVD player 1 is connected to a remote controller 2 in a manner such as to be communicatable therewith via infrared communication and also connected to the USB memory 3, a display 4, and a speaker 5 in a manner such as to be communicatable therewith.

The remote controller 2 (corresponding to part of a reproduction setting part) receives operation input from the user, generates an infrared signal corresponding to the operation input, and outputs it to the DVD player 1.

The USB memory 3 is a recording medium where audio information and image information are previously stored. The display 4 includes an LCD (Liquid Crystal Display) or the like, and displays various pieces of information in a manner such that the information can be viewed from the outside. The speaker 5 outputs the audio information stored in the USB memory 3 or the like to the outside.

The DVD player 1 includes: a microprocessor 11, an optical pickup 12, an RF circuit 13, an external interface 14, a USB interface 15, an interface 16, a display part 17, a memory 18, and an infrared signal reception pat 19.

The microprocessor 11 controls operation of the entire DVD player 1. The optical pickup 12 performs data reading (reproduction, playback) by irradiating a laser beam to a DVD (or CD) 10.

The RF circuit 13 processes an RF (Radio Frequency) signal outputted from the optical pickup 12. An external interface 14 performs, for example, data form conversion upon data input or output from an external input and output device to the DVD player 1 and vice versa. The USB interface 15 (corresponding to part of an installation judgment part, part of a stored information judgment part, and part of a reproduction execution part) obtains, via a USB terminal, the audio information or the like stored in the removable USB memory 3. The interface 16 transmits and receives various pieces of information, such as video information, audio information, guidance information, etc., to and from the display 4 and/or the speaker 5 via a cable.

The display part 17 includes, for example, an LCD (Liquid Crystal display) or the like, and displays various pieces of information, such as guidance information, message information, setting information, etc. in a manner such that the information can be viewed from the outside. The memory 18 stores the various pieces of information. The infrared signal reception pat 19 receives the infrared signal transmitted from the remote controller 2.

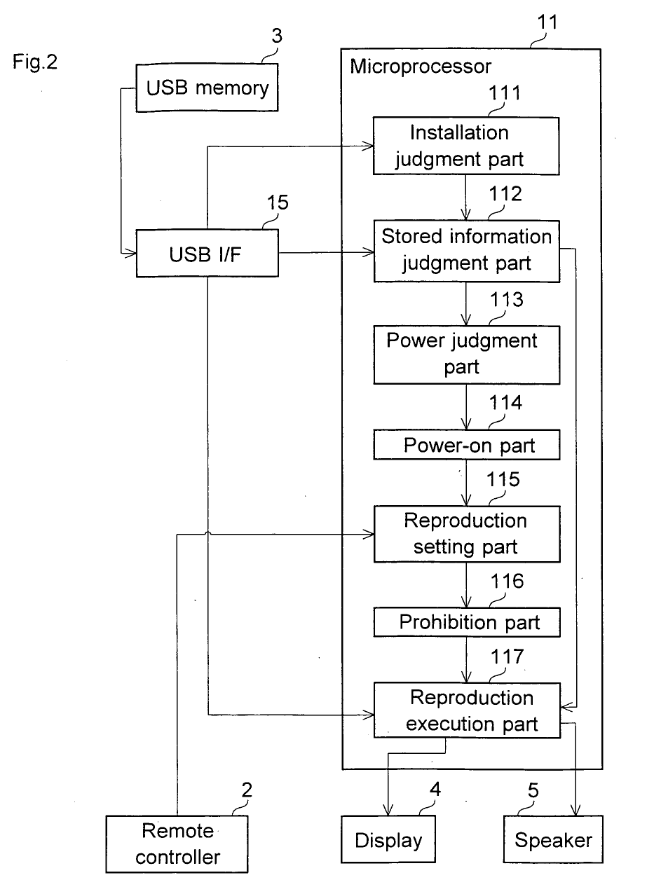

FIG. 2 is a functional configuration diagram showing one example of configuration of main parts in the DVD player 1 according to the invention. The microprocessor 11 is provided with, as its functions, an installation judgment part 111, a stored information judgment part 112, a power judgment part 113, a power-on part 114, a reproduction setting part 115, a prohibition part 116, and a reproduction execution part 117.

Specifically, the microprocessor 11, by reading and executing control programs previously stored in a ROM (Read Only Memory), not shown, or the like, functions as the installation judgment part 111, the stored information judgment part 112, the power judgment part 113, the power-on part 114, the reproduction setting part 115, the prohibition part 116, the reproduction execution part 117, etc.

Of the various data stored in the memory 18 or the ROM not shown, the data that can be stored in a removable recording medium may be adapted to be readable by drive units, such as a hard disk drive, an optical disk drive, a flexible disk drive, a silicone disk drive, a cassette medium reading device, etc. The recording medium in this case is, for example, a hard disk, an optical disk, a flexible disk, a CD, a DVD, a semiconductor memory, or the like.

The installation judgment part 111 (corresponding to part of the installation judgment part) judges, via the USB interface 15 every predetermined time previously set (for example, every second), whether or not the USB memory 3 has been installed.

The stored information judgment part 112 (corresponding to part of the stored information judgment part), if the installation judgment part 111 judges that the USB memory 3 has been installed, judges via the USB interface 15, whether or not the USB memory 3 stores reproducible information. Moreover, the stored information judgment part 112, if the installation judgment part 111 judges that the USB memory 3 has been installed, judges via the USB interface 15, whether or not the USB memory 3 stores a plurality of pieces of reproducible information.

The judgment on whether or not the information stored in the USB memory 3 is reproducible information is made based on, for example, an extension indicating a file form of FAT (File Allocation Tables) information stored in the USB memory 3. For example, if the file form is a file form of audio information such as an MP3 (Moving Picture Experts Group Audio Layer 3) form or a WMA (Windows Media Audio) form, or a file form of image information such as a JPEG (Joint Photographic Experts Group) form, it is judged that the information stored in the USB memory 3 is reproducible information.

Moreover, if the stored information judgment part 112 judges that the USB memory 3 stores no reproducible information, the stored information judgment part 112 displays, on the display 4 as part of an OSD (On-Screen Display), information indicating that no reproducible information is present (for example, character information, “the installed USB memory stores no reproducible information”).

The power judgment part 113 (corresponding to the power judgment part), if the installation judgment part 111 judges that the USB memory 3 has been installed, judges whether or not a power of the DVD player 1 is ON.

The power-on part 114 (corresponding to the power-on part), if the power judgment part 113 judges that the power is OFF, turns on the power of the DVD player 1.

The reproduction setting part 115 (corresponding to part of the reproduction setting part) receives operation input from the user via the remote controller 2, and based on the received operation input, sets whether or not to achieve reproduction from the information stored in the USB memory 3.

The prohibition part 116 (corresponding to the prohibition part), if the reproduction setting part 115 has set “reproduction is not to be achieved”, prohibits operation of the reproduction execution part 117.

The reproduction execution part 117 (corresponding to part of the reproduction execution part), if the stored information judgment part 112 judges that the USB memory 3 stores reproducible information, reads the reproducible information stored in the USB memory 3 to achieve reproduction, and outputs it to the display 4 or the speaker 5. The reproduction execution part 117 outputs the reproducible information to the speaker 5 when it is audio information and outputs the reproducible information to the display 4 when it is image information.

Moreover, the reproduction execution part 117, if the stored information judgment part 112 judges that the USB memory 3 stores a plurality of pieces of reproducible information, selects, from among the plurality of pieces of reproducible information, one piece of reproducible information located at the foremost side in the FAT stored in the USB memory 3, and then reads the selected one piece of reproducible information from the USB memory 3 to achieve reproduction.

However, the reproduction execution part 117, if the operation has been prohibited by the prohibition part 116, does not perform operation of reading the reproducible information from the USB memory 3 to achieve reproduction. Moreover, the reproduction execution part 117, if the operation has been prohibited by the prohibition part 116, generates as a file list a list of the reproducible information stored in the USB memory 3 and displays it on the display 4.

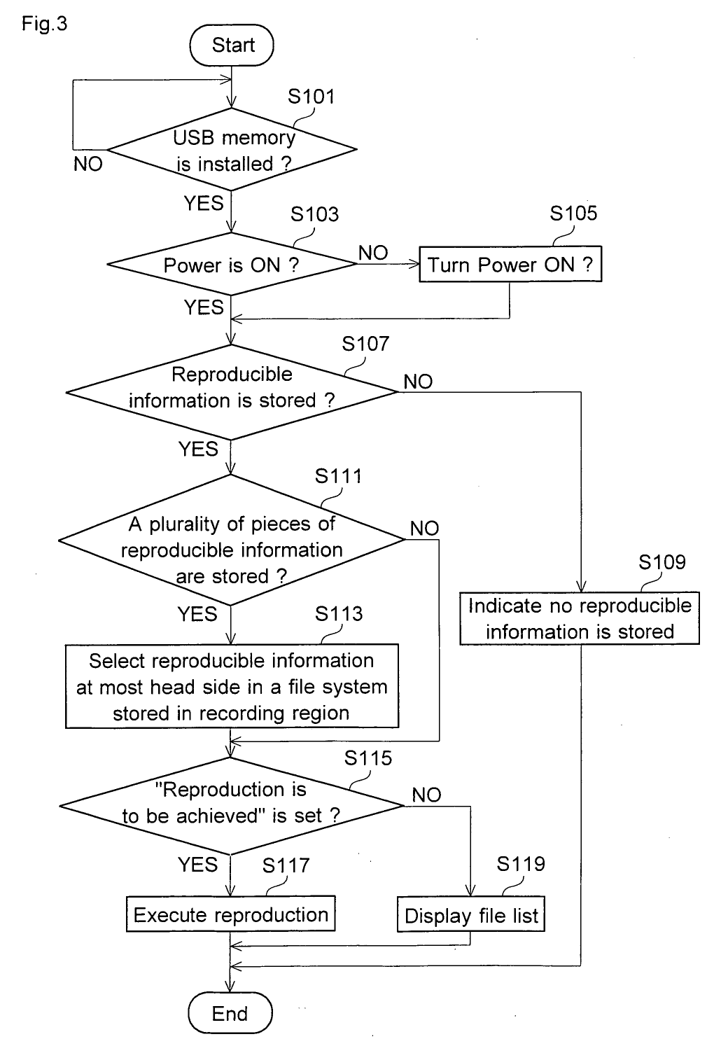

FIG. 3 is a flowchart showing one example of the operation performed by the DVD player 1 (mainly the microprocessor 11). Here, for convenience, a description will be given concerning a case where the reproduction setting part 115 sets whether or not to previously achieve reproduction. First, the installation judgment part 111 judges whether or not the USB memory 3 has been installed (S101). If the installation judgment part 111 judges that the USB memory 3 has not been installed yet (No in S101), the processing of step S101 is repeated.

If the installation judgment part 111 judges that the USB memory 3 has been installed (Yes in S101), the power judgment part 113 judges whether or not the power of the DVD player 1 is ON (S103). If the power judgment part 113 judges that the power of the DVD player 1 is ON (Yes in S103), the processing proceeds to S107. If the power source judgment part 113 judges that the power of the DVD player 1 is not ON (No in S103), The power-on part 114 turns on the power of the DVD player 1 (S105). After the processing of S105 ends, the processing proceeds to step S107.

Next, the stored information judgment part 112 judges whether or not the USB memory 3 stores reproducible information. If the stored information judgment part 112 judges that the USB memory 3 stores no reproducible information (No in step S107), the stored information judgment part 112 displays on the display 4 information indicating that no reproducible information is present (S109), and the processing ends. If the stored information judgment part 112 judges that the USB memory 3 stores reproducible information (Yes in S107), the stored information judgment part 112 judges whether or not the USB memory 3 stores a plurality of pieces of reproducible information (S111). If the stored information judgment part 112 judges that the USB memory 3 does not store a plurality of pieces of reproducible information (i.e., it stores one piece of reproducible information) (No in S111), the processing proceeds to step S115.

If the stored information judgment part 112 judges that the USB memory 3 stores a plurality of pieces of reproducible information (Yes in S111), the reproduction execution part 117 selects as reproduction target information the one piece of reproducible information located at the foremost side in the FAT stored in the USB memory 3 (S113). When the processing of step S113 ends or when the judgment in step S111 is No, the prohibition part 116 judges whether or not the reproduction setting part 115 has set “reproduction is to be achieved” (S115). If the reproduction setting part 115 has set “reproduction is to be achieved” (Yes in S115), the reproducible information is read from the USB memory 3 to achieve reproduction (S117), and the processing ends. If the reproduction setting part 115 has set “reproduction is not to be achieved” (No in S115), the reproduction execution part 117 displays, as a file list on the display 4, a list of the reproducible information stored in the USB memory 3 (S119), and the processing ends.

In this manner, if the installation judgment part 111 judges that the USB memory 3 has been installed and the stored information judgment part 112 judges that the USB memory 3 stores reproducible information, the DVD player 1 can start the reproduction from the reproducible information stored in the USB memory 3 without operation input by the user, so that the DVD player 1 can achieve with high convenience the reproduction from the reproducible information stored in the removable USB memory 3.

Moreover, if the installation judgment part 111 judges that the USB memory 3 has been installed and the power judgment part 113 judges that the power of the DVD player 1 is OFF, the power is turned ON, and thus the reproduction from the reproducible information stored in the USB memory 3 can be started without operation input by the user for turning the power on. Therefore, the DVD player 1 can achieve with even higher convenience the reproduction from the reproducible information stored in the removable USB memory 3.

Further, if the stored information judgment part 112 judges that the USB memory 3 stores a plurality of pieces of reproducible information, from among the plurality of pieces of reproducible information, one piece of reproducible information is selected in accordance with a previously set rule, and the selected one piece of reproducible information is read to achieve reproduction. Thus, even if the USB memory 3 stores a plurality of pieces of reproducible information, the DVD player 1 can start the reproduction from the reproducible information stored in the USB memory 3 without operation input by the user for selecting information from which reproduction is to be achieved. Therefore, the DVD player 1 can achieve with even higher convenience the reproduction from the reproducible information stored in the removable USB memory 3.

In addition, if the stored information judgment part 112 judges that the USB memory 3 stores a plurality of pieces of reproducible information, from among the plurality of pieces of reproducible information, one piece of reproducible information located at the foremost side in the FAT stored in the USB memory 3 is selected. At the same time, the selected one piece of reproducible information is read to achieve reproduction, so that the DVD player 1 can, through simple configuration and with even higher convenience, achieve the reproduction from the reproducible information stored in the removable USB memory 3.

Moreover, the operation input from the user is received via the remote controller 2, and based on the received operation input, the reproduction setting part 115 sets whether or not to achieve the reproduction from the information stored in the USB memory 3. If the user does not desire the reproduction, the user can prohibit the reproduction operation by setting via the remote controller 2 “reproduction is not to be achieved” (as the setting made by the reproduction setting part 115). Thus, the DVD player 1 can achieve with even higher convenience the reproduction from the reproducible information stored in the removable USB memory 3.

Further, the reproducible information is audio information and image information; therefore, the DVD player 1 can achieve with high convenience reproduction from the audio information and the image information stored in the removable USB memory 3.

The invention is also applicable to the following embodiments.

(A) This embodiment has been described, referring to a case where the optical disk player of the invention is the DVD player 1, but the optical disk player of the invention may be any device that reads reproducible information from a removable recording medium to achieve reproduction. For example, the optical disk player of the invention may be a CD player that reads audio information from a CD to achieve reproduction.

(B) This embodiment has been described, referring to a case where the recording medium is the USB memory 3, but it may be another type of removable recording medium. For example, the recording medium may be structured as a card memory.

(C) This embodiment has been described, referring to a case where the microprocessor 11 is provided with, as its functions, the installation judgment part 111, the stored information judgment part 112, the power judgment part 113, the power-on part 114, the reproduction setting part 115, the prohibition part 116, and the reproduction execution part 117. However, of the installation judgment part 111, the stored information judgment part 112, the power judgment part 113, the power-on part 114, the reproduction setting part 115, the prohibition part 116, and the reproduction execution part 117, at least one functional part may be formed with hardware such as a circuit.

(D) This embodiment has been described, referring to a case where the reproducible information is audio information and image information. However, the reproducible may be audio information or image information, or another type of information (for example, video information).

(E) This embodiment has been described, referring to a case where from among a plurality of pieces of reproducible information, one piece of reproducible information located at the foremost side in the FAT stored in the USB memory 3 is selected. However, the reproduction execution part 117 may select one piece of reproducible information by another method. For example, the reproduction execution part 117 may select, with reference to the FAT, reproducible information that has been stored on the latest date (most recently). Moreover, for example, the reproduction execution part 117 may, with reference to the FAT, randomly select reproducible information.

(F) In this embodiment, as a file system in a recording medium such as the USB memory 3, the FAT are used; however, the file system in the recording medium such as the USB memory 3 in the invention is not limited to the FAT, and thus another file system may be used. Examples of another file system include: VFAT, FAT32, and NTFS used in an OS such as Windows; HFS and HFS+ used in an OS such as Mackintosh; etc.

What is claimed is:

1. An optical disk player comprising:
an installation judgment part judging whether or not a removable recording medium has been installed;
a stored information judgment part, when the installation judgment part judges that the recording medium has been installed, judging whether or not the recording medium stores reproducible information; and
a reproduction execution part, when the stored information judgment part judges that the recording medium stores the reproducible information, reading the reproducible information to achieve reproduction.

2. The optical disk player according to claim 1, further comprising:
a power judgment part, when the installation judgment part judges that the recording medium has been installed, judging whether a power of the optical disk player is ON or OFF; and
a power-on part, when the power judgment part judges that the power is OFF, turning the power ON.

3. The optical disk player according to claim 1,
wherein the stored information judgment part judges whether or not the recording medium stores a plurality of pieces of the reproducible information,
wherein, when the stored information judgment part judges that the recording medium stores the plurality of pieces of the reproducible information, the reproduction execution part selects, from among the plurality of pieces of the reproducible information, one piece of the reproducible information in accordance with a preset rule, and
wherein the selected one piece of the reproducible information is read to achieve the reproduction.

4. The optical disk player according to claim 1, further comprising:
a reproduction setting part receiving operation input from outside, and based on the received operation input, setting whether or not the reproduction execution part performs the reproduction from the information stored in the recording medium; and
a prohibition part, when the reproduction setting part has set “reproduction is not to be achieved”, prohibiting operation of the reproduction execution part.

5. The optical disk player according to claim 1,
wherein the reproducible information is at least either of audio information and image information.

6. The optical disk player according to claim 1,
wherein the recording medium is a USB memory.

7. The optical disk player according to claim 2,
wherein the stored information judgment part judges whether or not the recording medium stores a plurality of pieces of the reproducible information,
wherein, when the stored information judgment part judges that the recording medium stores the plurality of pieces of the reproducible information, the reproduction execution part selects, from among the plurality of pieces of the reproducible information, one piece of the reproducible information in accordance with a preset rule, and
wherein the selected one piece of the reproducible information is read to achieve the reproduction.

8. The optical disk player according to claim 3,
wherein, when the stored information judgment part judges that the recording medium stores the plurality of pieces of the reproducible information, the reproduction execution part selects, from among the plurality of pieces of the reproducible information, one piece of the reproducible information located at a foremost side in File Allocation Tables stored in the recording medium, and
wherein the selected one piece of the reproducible information is read to achieve the reproduction.

9. The optical disk player according to claim 7,
wherein, when the stored information judgment part judges that the recording medium stores the plurality of pieces of the reproducible information, the reproduction execution part selects, from among the plurality of pieces of the reproducible information, one piece of the reproducible information located at a foremost side in File Allocation Tables stored in the recording medium, and
wherein the selected one piece of the reproducible information is read to achieve the reproduction.

10. The optical disk player according to claim 3,
wherein, when the stored information judgment part judges that the recording medium stores the plurality of pieces of the reproducible information, the reproduction execution part selects, from among the plurality of pieces of the reproducible information, one piece of the reproducible information located at a foremost side in a file system stored in the recording medium, and
wherein the selected one piece of the reproducible information is read to achieve the reproduction

11. The optical disk player according to claim 7,
wherein, when the stored information judgment part judges that the recording medium stores the plurality of pieces of the reproducible information, the reproduction execution part selects, from among the plurality of pieces of the reproducible information, one piece of the reproducible information located at a foremost side in a file system stored in the recording medium, and
wherein the selected one piece of the reproducible information is read to achieve the reproduction
